(19) United States
(12) Patent Application Publication
(10) Pub. No.: US 2026/0205513 A1
(43) Pub. Date: Jul. 16, 2026

(54) PRIMARY NODE ELECTION IN KNOWN GROUP

(71) Applicant: Dell Products L.P., Round Rock, TX (US)

(72) Inventors: Vivian Ziqin JIAN, Shanghai (CN); Weiyi XIE, Wuxi (CN); Zhenyu QI, Shanghai (CN); Yun SUN, Wuxi (CN); Wei ZHANG, Lexington, MA (US); Xue LI, Shanghai (CN); Johnson MA, Shanghai (CN); Davina LI, Shanghai (CN)

(73) Assignee: Dell Products L.P., Round Rock, TX (US)

(21) Appl. No.: 19/025,253

(22) Filed: Jan. 16, 2025

(51) Int. Cl. H04L 67/104; H04L 12/46

(52) U.S. Cl. CPC H04L 67/1051; H04L 12/4641

(57) ABSTRACT

An information handling system may be configured to: perform an election among a plurality of nodes of an information handling system cluster to determine a primary node, wherein each node has an associated network address, unique identifier, and state designator, by: causing each node to repeatedly transmit messages to other nodes of the information handling system cluster, the messages including each respective node's network address, unique identifier, and state designator; causing each node to determine, based on the messages, a particular node having an extremal value of the unique identifier; causing the particular node to update its state designator to a primary designator; causing a remainder of the plurality of nodes to update their state designators to a secondary designator; and electing the particular node as the primary node; and cause the primary node to perform provisioning of the cluster of information handling systems.

### TECHNICAL FIELD

The present disclosure relates in general to information handling systems, and more particularly to the election of a primary node in a cluster of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as clusters such as software-defined storage (SDS) cluster systems (e.g., an SDS cluster system such as the VMware® vSAN™ system, or any other cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In some cases, an HCI cluster may elect one node as its primary node, which can then act as the bootstrap node for setting up and provisioning the cluster, as well as performing other tasks. The primary node may be elected by first powering on the nodes of the cluster and allowing them to auto-discover each other over the network (e.g., by using mDNS or any other suitable technique for sharing information about themselves). Once the nodes have discovered one another, an election process may take place to select one node as primary.

For example, in one implementation, some designated characteristic of the nodes such as a unique identifier (e.g., their serial numbers) may be compared. For example, the node with an extremal value for the unique identifier (e.g., the node with the lowest serial number) may then be designated as the primary node. The primary node may present a wizard to the user to input information for cluster provisioning, and it may then handle the rest of the provisioning process.

The auto-discovery scenario mentioned above may be suitable in situations where the nodes do not yet know one another's network addresses, but they are all in the same broadcast domain (e.g., within a single virtual local area network (VLAN)). However, it may not be suitable when the nodes are not in the same broadcast domain, but they do already have one another's network addresses. This scenario may arise, for example, when an existing cluster is being reimaged to serve a different purpose.

Embodiments of this disclosure are thus directed to techniques for primary node election in the second scenario.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with primary node election may be reduced or eliminated.

In accordance with embodiments of the present disclosure, an information handling system may include at least one processor and a memory. The information handling system may be configured to: perform an election among a plurality of nodes of an information handling system cluster to determine a primary node, wherein each node has an associated network address, unique identifier, and state designator, by: causing each node to repeatedly transmit messages to other nodes of the information handling system cluster, the messages including each respective node's network address, unique identifier, and state designator; causing each node to determine, based on the messages, a particular node having an extremal value of the unique identifier; causing the particular node to update its state designator to a primary designator; causing a remainder of the plurality of nodes to update their state designators to a secondary designator; and electing the particular node as the primary node; and cause the primary node to perform provisioning of the cluster of information handling systems.

In accordance with these and other embodiments of the present disclosure, a method may include an information handling system performing an election among a plurality of nodes of an information handling system cluster to determine a primary node, wherein each node has an associated network address, unique identifier, and state designator, by: causing each node to repeatedly transmit messages to other nodes of the information handling system cluster, the messages including each respective node's network address, unique identifier, and state designator; causing each node to determine, based on the messages, a particular node having an extremal value of the unique identifier; causing the particular node to update its state designator to a primary designator; causing a remainder of the plurality of nodes to update their state designators to a secondary designator; and electing the particular node as the primary node; and the information handling system causing the primary node to perform provisioning of the cluster of information handling systems.

In accordance with these and other embodiments of the present disclosure, an article of manufacture may include a non-transitory, computer-readable medium having computer-executable instructions thereon that are executable by an information handling system for: performing an election among a plurality of nodes of an information handling system cluster to determine a primary node, wherein each node has an associated network address, unique identifier, and state designator, by: causing each node to repeatedly transmit messages to other nodes of the information handling system cluster, the messages including each respective node's network address, unique identifier, and state designator; causing each node to determine, based on the messages, a particular node having an extremal value of the unique identifier; causing the particular node to update its state designator to a primary designator; causing a remainder of the plurality of nodes to update their state designators to a secondary designator; and electing the particular node as the primary node; and causing the primary node to perform provisioning of the cluster of information handling systems.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of a cluster of information handling systems, in accordance with embodiments of the present disclosure; and

FIG. 3 illustrates a block diagram of a cluster of information handling systems, in accordance with embodiments of the present disclosure.

### DETAILED DESCRIPTION

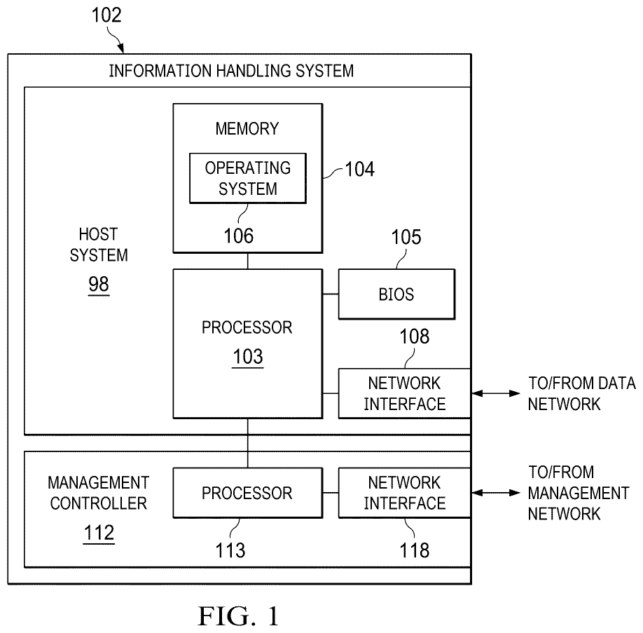

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may be used to elect a primary node in a cluster of information handling systems 102. For the sake of concreteness, the following discussion addresses a cluster including three nodes that are not all in the same broadcast domain.

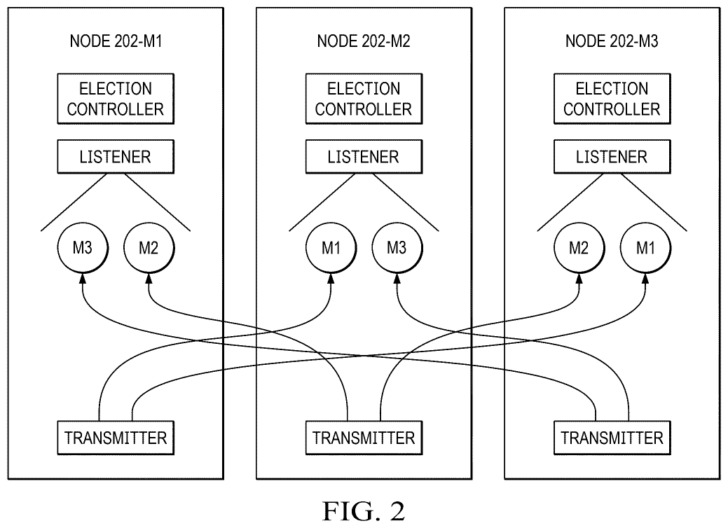

FIG. 2 shows an example of such a cluster, including nodes 202-M1, 202-M2, and 202-M3. As shown, each node may be provisioned with three modules that are relevant to the election procedure.

A transmitter module is used to send information about its node to the other nodes. For example, the transmitter may send the node's network address (e.g., an IPv4 address, an IPv6 address, or any other suitable address), its serial number, a state designator, and any other information useful for provisioning and/or for election of the primary node (e.g., node health information, etc.). As discussed below, the state designator may take on values such as “initial”, “primary”, or “secondary”. The initial value is used before a primary node is elected, primary is used by the primary node, and secondary is used by the other nodes. Because the nodes are already known to one another, the transmitter module may already be in possession of the network addresses of the other nodes. Accordingly, the transmitter may use ordinary (e.g., non-multicast) routed packets to send this information.

A listener module may implement a RESTful API that is used to receive the information transmitted by the transmitter modules of other nodes.

Finally, an election controller module may run as a daemon service on each node and may be used to orchestrate the overall process. For example, the election controller may be configured to invoke the transmitter to send information to the other nodes, as well as collect the information received by the listener module from those other nodes. As discussed in more detail below, the election controllers on the respective nodes may also carry out the election procedure once the nodes have exchanged their information.

Because each node has the capability to be elected as the primary node, the cluster has multiple opportunities to elect a healthy node, avoiding the possibility that a previously elected node becomes non-functional or enters a degraded state.

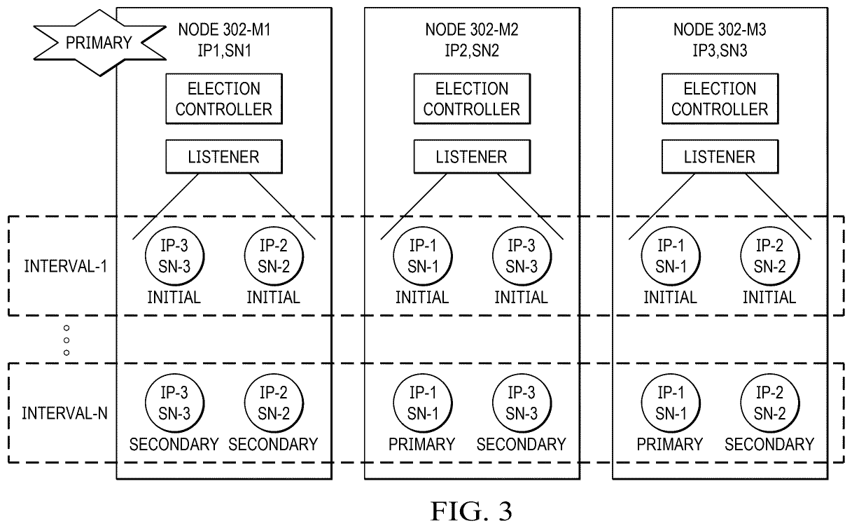

FIG. 3 illustrates a cluster carrying out the election procedure. Node 302-M1 has network address IP-1 and serial number SN-1, and the other nodes have corresponding network addresses and serial numbers. For the sake of simplicity, FIG. 3 does not explicitly show the nodes' transmitter modules.

As shown, the election procedure may proceed iteratively during successive intervals. Each election controller may execute a loop (e.g., running once every three seconds or at any other suitable frequency) to invoke its transmitter module to send its node information, including the node's IP address, serial number, and current state designator. Each listener module may receive these messages from the other nodes and save them as a message queue.

In the first interval, each transmitter module may send a message to the other nodes with the state designator set to the initial value. Each listener module may receive these messages and add them to the message queue.

Based on the message queues, the election controller on the node with the lowest serial number may then change its state designator to primary. The other election controllers may change their state designators to secondary. Each node may then re-transmit their updated information to the other nodes at the next interval.

This process may continue until all of the nodes agree on which node is primary. For example, if the node with the lowest serial number cannot serve as primary (e.g., due to a malfunction), then in that interval no message may be received with a state designator set to primary. Then, in the following interval, the node with the next lowest serial number may change its state designator to primary, etc.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
perform an election among a plurality of nodes of an information handling system cluster to determine a primary node, wherein each node has an associated network address, unique identifier, and state designator, by:
causing each node to repeatedly transmit messages to other nodes of the information handling system cluster, the messages including each respective node's network address, unique identifier, and state designator;
causing each node to determine, based on the messages, a particular node having an extremal value of the unique identifier;
causing the particular node to update its state designator to a primary designator;
causing a remainder of the plurality of nodes to update their state designators to a secondary designator; and
electing the particular node as the primary node; and
cause the primary node to perform provisioning of the cluster of information handling systems.

2. The information handling system of claim 1, wherein the information handling system cluster is a hyper-converged infrastructure (HCI) cluster.

3. The information handling system of claim 1, wherein the unique identifier is a serial number.

4. The information handling system of claim 3, wherein the extremal value of the unique identifier is a lowest serial number.

5. The information handling system of claim 1, wherein at least two of the nodes are communicatively coupled to different virtual local area networks (VLANs).

6. The information handling system of claim 1, wherein the messages are transmitted as routable internet protocol (IP) packets.

7. A method comprising:
an information handling system performing an election among a plurality of nodes of an information handling system cluster to determine a primary node, wherein each node has an associated network address, unique identifier, and state designator, by:
causing each node to repeatedly transmit messages to other nodes of the information handling system cluster, the messages including each respective node's network address, unique identifier, and state designator;
causing each node to determine, based on the messages, a particular node having an extremal value of the unique identifier;
causing the particular node to update its state designator to a primary designator;
causing a remainder of the plurality of nodes to update their state designators to a secondary designator; and
electing the particular node as the primary node; and
the information handling system causing the primary node to perform provisioning of the cluster of information handling systems.

8. The method of claim 7, wherein the information handling system cluster is a hyper-converged infrastructure (HCI) cluster.

9. The method of claim 7, wherein the unique identifier is a serial number.

10. The method of claim 9, wherein the extremal value of the unique identifier is a lowest serial number.

11. The method of claim 7, wherein at least two of the nodes are communicatively coupled to different virtual local area networks (VLANs).

12. The method of claim 7, wherein the messages are transmitted as routable internet protocol (IP) packets.

13. An article of manufacture comprising a non-transitory, computer-readable medium having computer-executable instructions thereon that are executable by an information handling system for:
performing an election among a plurality of nodes of an information handling system cluster to determine a primary node, wherein each node has an associated network address, unique identifier, and state designator, by:
causing each node to repeatedly transmit messages to other nodes of the information handling system cluster, the messages including each respective node's network address, unique identifier, and state designator;
causing each node to determine, based on the messages, a particular node having an extremal value of the unique identifier;
causing the particular node to update its state designator to a primary designator;
causing a remainder of the plurality of nodes to update their state designators to a secondary designator; and
electing the particular node as the primary node; and
causing the primary node to perform provisioning of the cluster of information handling systems.

14. The article of manufacture of claim 13, wherein the information handling system cluster is a hyper-converged infrastructure (HCI) cluster.

15. The article of manufacture of claim 13, wherein the unique identifier is a serial number.

16. The article of manufacture of claim 15, wherein the extremal value of the unique identifier is a lowest serial number.

17. The article of manufacture of claim 13, wherein at least two of the nodes are communicatively coupled to different virtual local area networks (VLANs).

18. The article of manufacture of claim 13, wherein the messages are transmitted as routable internet protocol (IP) packets.
